(19) United States
(12) Patent Application Publication
(10) Pub. No.: US 2009/0277254 A1
(43) Pub. Date: Nov. 12, 2009

(54) METHODS OF IMPROVING PACKED-BED CHROMATOGRAPHY PERFORMANCE

(75) Inventors: Brad M. Matanin, Rockville, MD (US); David A. Page, Gaithersburg, MD (US)

Correspondence Address: MEDIMMUNE, LLC;Patrick Scott Alban, ONE MEDIMMUNE WAY, GAITHERSBURG, MD, 20878, US

(73) Assignee: Medlmmune, LLC, Gaithersburg, MD (US)

(21) Appl. No.: 12/437,772

(22) Filed: May 8, 2009

Related U.S. Application Data
(60) Provisional application No. 61/051,855, filed on May 9, 2008.

(51) Int. Cl. G01N 30/02

(52) U.S. Cl. 73/61.53

(57) ABSTRACT

The invention provides methods of improving packed bed chromatography performance.

### 1. CROSS-REFERENCE TO RELATED APPLICATIONS

This application claims benefit of U.S. Provisional Application No. 61/051,855, filed May 9, 2008, which is incorporated by reference in its entirety.

### 2. BACKGROUND OF THE INVENTION

With the marketing of protein products on the rise, the demand for efficient production of such products is ever increasing. As such, the longevity and reliability of highly complex and expensive liquid chromatography media has become paramount. It is expected that a typical packed-bed chromatography column should routinely last upwards of 50 cycles or more before a replacement is necessary during a production campaign. Unfortunately, often is the case where the integrity of the column becomes compromised much earlier and leads to loss of the protein product and increased production efforts.

Production scale packed bed chromatography columns often develop channels in which the solution runs through without interacting with the medium. It is these channels which often lead to losses in recovery of the protein product and require repacking of the chromatography bed. The production scale chromatography columns are used in successive cycles, each of which comprise a separation step, a wash/strip step, and a storage step. It is thought that the medium undergoes a particular change (such as size) during each cycle and it is this change that may lead to the formation of channels as the cycle number increases.

It is an object of the invention to characterize such changes in the chromatography medium and correlate the changes with the formation of channels in the packed-bed column. The use of such a method could greatly improve the efficient production of protein pharmaceuticals by reducing product loss and production time.

### 3. SUMMARY OF THE INVENTION

In one embodiment, the invention provides methods of improving packed-bed chromatography (hereinafter referred to as “methods of the invention”). In some embodiments, a method of the invention includes the measurement of particle size changes of chromatography media that have been subjected to changes in buffer conductivity, pH, or temperature. In other embodiments, a method of the invention further includes the characterization of the particle size changes in relation to packed-bed chromatography performance.

### 4. BRIEF DESCRIPTION OF THE FIGURES

FIG. 1. HCIC medium size distribution in process buffers. Bead size increases in low pH (pH 3.0) buffer. The reported pKa of the medium is 4.8. This suggests that changes in bead size may be attributed to induced electrostatic repulsion at pH<4.8.

FIG. 2. Measure of bed integrity volume (V_{BI}) representative of a high integrity packed bed. V_{BI} is the volume difference (expressed as column volumes) between the retention peak, or maximum rate of change of conductivity with respect to volume, and the 2.5% breakthrough volume, or the volume where the outlet conductivity reaches 2.5% of the total transition between sanitization and storage.

FIG. 3. Measure of bed integrity volume (V_{BI}) representative of a low integrity packed bed. As the column integrity degrades, V_{BI} increases.

FIG. 4. Qualitative overlays of rate of change of conductivity versus totalized volume for process cycles with low pH buffer. Decrease in column integrity was evident by decreased 2.5% breakthrough volume, increased zone broadening, the formation of multiple inflection peaks, and increase in bed integrity volume (V_{BI}).

FIG. 5. Qualitative overlays of rate of change of conductivity versus totalized volume for process cycles with the low pH buffer omitted. Bed integrity did not degrade as rapidly during the first 6 cycles when bead size remains constant.

FIG. 6. Effect of low pH buffer on bed integrity volume (V_{BI}) after 12 process cycles. V_{BI} values increased dramatically over the first three process cycles when the low pH buffer was included. Column integrity during early cycles was maintained when this buffer was omitted.

FIG. 7. Effect of low pH buffer on HETP-NG after 12 process cycles. HETP-NG values increase at a higher rate during early cycles when the low pH buffer was included. Column integrity during early cycles was better maintained when the low pH buffer was omitted.

FIG. 8. Real time pH and particle size data demonstrates the effect of pH on particle size. The median diameter of MEP Hypercel beads decreased as the pH was increased by the titration of sodium hydroxide as measured in real time by the Horiba system.

### 5. DETAILED DESCRIPTION

The inventors found that various chromatography media exhibited a particle size shift when subjected to a pH or conductivity change in the buffer the medium was subjected to. The inventors further correlated the size change with the formation of channels in packed bed chromatography columns, a very undesirable situation where recovery losses readily occur. As such, the inventors further developed a method of optimizing packed bed column performance by correlating the size changes exhibited by a particular medium with the formation of channels was likely to occur.

### 5.1 Transition Analysis

To assess the performance of chromatography columns, the process of transition analysis is employed. Transition analysis utilizes process data to monitor the performance of packed bed columns. A chromatographic transition is the response at the outlet of the column to a step change at the column's inlet. For example, a column equilibrated with a low salt buffer and eluted with a high salt buffer will have a low to high transition, which can be measured at the column outlet. Transition analysis utilizes pH, conductivity, and optical density data from the column outlet to assess the condition of the packed bed in the column. The data derived from transition analysis are quantitative and sensitive to subtle changes in performance. Transition analysis is often used to identify integrity breaches in the packed bed, such as, but not limited to channel formation.

### 5.2 Height Equivalent of a Theoretical Plate (HETP) Analysis

Columns, both for analytical and for preparatory purposes, vary in their efficiency, which is one of the two parameters that characterize their ability to separate the constituents in a sample (the other being the differences between the equilibrium constants of the compounds of interest). Efficiency is often expressed in terms of the number (N) of theoretical plates in the column.

A theoretical plate is the length of a column that allows for one complete equilibration of the sample between the mobile and the stationary phases. Because the number of theoretical plates will vary according to the length (L) of a column and depending on the packing of the column, the concept referred to as the Height Equivalent to a Theoretical Plate (HETP) is used to compare the efficiency of two or more columns of the same or different lengths or to compare the same column under differing conditions. The condition and/or integrity of a column may be assessed after each cycle by monitoring the HETP values. A further discussion of HETP analysis may be found in “Use Of Process Data To Assess Chromatographic Performance In Production-Scale Protein Purification Columns” by Larson et al. (2003) Biotechnol. Prog. 19, 485-492.

### 5.3 Particle Size Analysis

Packed-bed chromatography columns are made up of media of various materials that either passively or actively participate in the separation process. Many media are derived from inert sugar and/or polysaccharide materials which are coupled to functional groups that selectively bind molecules based on a charge and/or hydrophobic interaction. Theses media are often of a uniform size to increase reproducibility in separation processes.

One method of measuring the particle size of medium beads is by laser scattering. This methodology depends upon the analysis of the “halo” of diffracted light produced when a laser beam passes through a dispersion of particles in a liquid. The angle of diffraction increases as particle size decreases, so that this method is particularly good for measuring sizes below 1 μm. A particular advantage is that the technique can generate a continuous measurement for analyzing process streams. Other methods to measure particle size include sieve analysis, optical counting, electrical counting, sedimentation, and acoustic spectroscopy.

In one embodiment, the method of the invention comprises the measurement of particle size by Laser scattering. In a specific embodiment, the Laser scattering is measured by a laser scattering particle size distribution analyzer. Such distribution analyzers are available from commercial sources, such as the LA-950V2 from Horiba Instruments Inc.

In some embodiments, the methods of the invention comprise monitoring particle size of the medium after a chromatography cycle. A chromatography cycle refers to a complete cycle of loading the sample on the medium, washing undesirable materials off the medium, eluting the desired protein, and regeneration of the column for loading of a subsequent sample.

### 5.4 Chromatography Processes

The methods of the invention are widely applicable to a variety of packed-bed chromatography processes. In some embodiments, the methods of the invention comprise ion-exchange, reversed-phase, cation exchange, anion exchange, size exclusion, hydrophobic charge induction, affinity, and hydrophobic interaction chromatography.

Hydrophobic charge induction chromatography (or “HCIC”) is a type of mixed mode chromatographic process in which the protein of interest in the mixture binds to a dual mode medium through mild hydrophobic interactions in the absence of added salts (for example a lyotropic salts) (Schwart et al. J Chromatogr, 2001; 908(1-2):251-63.

Hydrophobic charge induction chromatography medium is a solid phase that contains a ligand which has the combined properties of thiophilic effect (i.e., utilizing the properties of thiophilic chromatography), hydrophobicity and an ionizable group for its separation capability. Thus, an HCIC medium used in a method of the invention contains a ligand that is ionizable and mildly hydrophobic at neutral (physiological) or slightly acidic pH, for example, about pH 5 to 10, or about pH 6 to 9.5. At this pH range, the ligand is predominantly uncharged and binds a protein of interest via mild non-specific hydrophobic interaction. As pH is reduced, the ligand acquires charge and hydrophobic binding is disrupted by electrostatic charge repulsion towards the solute due to the pH shift.

Examples of suitable ligands for use in HCIC include any ionizable aromatic or heterocyclic structure (for example those having a pyridine structure, such as 2-aminomethylpyridine, 3-aminomethylpyridine and 4-aminomethylpyridine, 2-mercaptopyridine, 4-mercaptopyridine or 4-mercaptoethylpyridine, mercaptoacids, mercaptoalcohols, imidazolyl based, mercaptomethylimidazole, 2-mercaptobenzimidazole, aminomethylbenzimidazole, histamine, mercaptobenzimidazole, diethylaminopropylamine, aminopropylmorpholine, aminopropyl imidazole, aminocaproic acid, nitrohydroxybenzoic acid, -14-nitrotyrosine/ethanolamine, dichiorosalicylic acid, dibromotyramine, chlorohydroxyphenylacetic acid, hydroxyphenylacetic acid, tyramine, thiophenol, glutathione, bisuiphate, and dyes, including derivatives thereof see Burton and Harding, Journal of Chromatography A 814: 8 1-81 (1998) and Boschetti, Journal of Biochemical and Biophysical Methods 49: 361-389 (2001), which has an aliphatic chain and at least one sulfur atom on the linker arm and/or ligand stricture. A non-limiting example of an HCIC medium includes MEP HYPERCEL® (Pall Corporation; East Hills, N.Y.).

Ion-exchange chromatography refers to a chromatographic process in which an ionizable solute of interest (for example, a protein of interest in a mixture) interacts with an oppositely charged ligand linked (for example, by covalent attachment) to a solid phase ion exchange material under appropriate conditions of pH and conductivity, such that the solute of interest interacts non-specifically with the charged compound more or less than the solute impurities or contaminants in the mixture. The contaminating solutes in the mixture can be washed from a column of the ion exchange material or are bound to or excluded from the medium, faster or slower than the solute of interest. Ion-exchange chromatography specifically includes cation exchange, anion exchange, and mixed mode chromatographies.

Cation exchange media refer to a solid phase which is negatively charged, and which has free cations for exchange with cations in an aqueous solution passed over or through the solid phase. Any negatively charged ligand attached to the solid phase suitable to form the cation exchange medium can be used, for example, a carboxylate, sulfonate and others as described below. Commercially available cation exchange media include, but are not limited to, for example, those having a sulfonate based group (for example, MonoS, MiniS, Source 15S and 30S, SP Sepharose Fast Flow, SP Sepharose High Performance from GE Healthcare, Toyopearl SP-650S and SP-650M from Tosoh, Macro-Prep High S from BioRad, Ceramic HyperD 5, Trisacryl M and LS SP and Spherodex LS SP from Pall Technologies); a sulfoethyl based group (for example, Fractogel SE, from EMD, Poros S- and S-20 from Applied Biosystems); a suiphopropyl based group (for example, TSK Gel SP 5PW and SP-5PW-HR from Tosoh, Poros HS-20 and HS-50 from Applied Biosystems); a sulfoisobutyl based group (for example, (Fractogel EMD SO₃ from EMD); a sulfoxyethyl based group (for example, SE52, SE53 and Express-Ion S from Whatman), a carboxymethyl based group (for example, CM Sepharose Fast Flow from GE Healthcare, Hydrocell CM from Biochrom Labs Inc., Macro-Prep CM from BioRad, Ceramic HyperD CM, Trisacryl M CM, Trisacryl LS CM, from Pall Technologies, Matrx Cellufine C500 and C200 from Millipore, CM52, CM32, CM23 and Express Ion C from Whatman, Toyopearl CM-650S, CM-650M and CM-650C from Tosoh); sulfonic and carboxylic acid based groups (for example BAKERBOND Carboxy-Sulfon from J. T. Baker); a carboxylic acid based group (for example, WP CBX from J. T Baker, DOWEX MAC-3 from Dow Liquid Separations, Amberlite Weak Cation Exchangers, DOWEX Weak Cation Exchanger, and Diaion Weak Cation Exchangers from Sigma-Aldrich and Fractogel EMD COO—from EMD); a sulfonic acid based group (e.g., Hydrocell SP from Biochrom Labs Inc., DOWEX Fine Mesh Strong Acid Cation Resin from Dow Liquid Separations, UNOsphere 5, WP Sulfonic from J. T. Baker, Sartobind S membrane from Sartorius, Amberlite Strong Cation Exchangers, DOWEX Strong Cation and Diaion Strong Cation Exchanger from Sigma-Aldrich); and a orthophosphate based group (for example, P11 from Whatman).

Anion exchange media refer to a solid phase which is positively charged, and which has free anions for exchange with anions in an aqueous solution passed over or through the solid phase. The functional groups of anion exchange media are typically tertiary or quaternary amino groups and include diethylaminoethyl (DEAE) groups, quaternary aminoethyl groups and quaternary ammonium groups. Matrices include agarose beads, dextran beads, polystyrene beads, and other matrices. Examples of commercially available (e.g., from Amersham Biosciences, now GE Healthcare, and Sigma-Aldrich) anion exchange media include DEAE-SEPHAROSE, Q SEPHAROSE and others. Other suitable anion-exchange chromatography materials, as well as the selection and use of these materials for the present application, are conventional in the art.

### 5.5 Buffer Compositions and Variations Thereof

There are a wide range of buffers that are suitable for use in the chromatographic separation of proteins. Such buffers include, but are not limited to acetate, citrate, histidine, phosphate, ammonium buffers such as ammonium acetate, succinate, 18-MES, CHAPS, MOPS, MOPSO, HEPES, Tris, and the like, as well as combinations of these TRIS-malic acid-NaOH, maleate, chioroacetate, formate, benzoate, propionate, pyridine, piperazine, ADA, PIPES, ACES, BES, TES, tricine, bicine, TAPS, ethanolamine, CHES, CAPS, methylamine, piperidine, o-boric acid, carbonic acid, lactic acid, butaneandioic acid, diethylmalonic acid, glycyiglycine, HEPPS, HEPPSO, imidazole, phenol, POPSO, succinate, TAPS, amine-based, benzylamine, trimethyl or dimethyl or ethyl or phenyl amine, ethylenediamine, or mopholine.

Additional components can be present in a buffer as needed, for example, but not limited to, salts can be used to adjust buffer ionic strength. Non-limiting examples include, sodium chloride, sodium sulfate and potassium chloride; and other additives such as amino acids (such as glycine and histidine), chaotropes (such as urea), alcohols (such as ethanol, marinitol, glycerol, and benzyl alcohol), detergents, and sugars (such as sucrose, mannitol, maltose, trehalose, glucose, and fructose). The buffer components and additives, and the concentrations used, can vary according to the type of chromatography practiced in the invention.

The pH and conductivity of the buffers can vary depending on which step in the purification process the buffer is used. For example, the wash step during chromatography often employs a low pH (stripping) step. As such, it is contemplated that the methods of the invention also include buffers with varying pH values.

In some embodiments, the methods of the invention comprise varying the pH of a buffer, wherein said buffer pH is varied from a first pH to a second pH, the second pH being lower than said first pH. In other embodiments, the methods of the invention comprise varying the pH of a buffer, wherein said buffer pH is varied from a first pH to a second pH, the second pH being higher than said pH.

In specific embodiments, the methods of the invention comprise varying the pH of a buffer, wherein said pH is varied from around 7.0 pH units to about 5.2 pH units. In other specific embodiments, methods of the invention comprise varying the pH of a buffer, wherein said pH is varied from about 5.2 pH units to about 3.0 pH units. In yet other specific embodiments, methods of the invention comprise varying the pH of a buffer, wherein said pH is varied from about 3.0 pH units to about 7.0 pH units. In other specific embodiments, methods of the invention comprise varying the pH of a buffer, wherein said pH is varied in a first step from about 7.0 pH units to about 5.2 pH units, and varied in a second step from about 5.2 pH units to about 3.0 pH units, and varied in a third step from about 3.0 pH units to about 7.0 pH units. In a specific embodiment, methods of the invention comprise repeating a cycle of three pH changes said first, second and third steps sequentially and measuring the particle size change of the medium after each cycle.

In other embodiments the methods of the invention comprise subjecting the medium to a pH of greater than or equal to 12 pH units. In further embodiments, methods of the invention comprise subjecting the medium to a solution of sodium hydroxide at a concentration from about 0.1 N to about 1.0 N.

In some embodiments, methods of the invention comprise changing the buffer composition from a first buffer to a second buffer, said second buffer different from the first buffer. In other embodiments, methods of the invention comprise changing the conductivity of the buffer composition. In some embodiments, methods of the invention comprise changing the conductivity of a buffer from a first conductivity to a second conductivity wherein the second conductivity is higher than the first conductivity. In alternative embodiments, methods of the invention comprise changing the conductivity of a buffer from a first conductivity to a second conductivity wherein the second conductivity is lower than the first conductivity.

In some embodiments, methods of the invention comprise altering the buffer conductivity from about 1 mS/cm to about 200 mS/cm. In other embodiments, methods of the invention comprise altering buffer conductivity from about 1 mS/cm to about 10 mS/cm, from about 1 mS/cm to about 25 mS/cm, from about 1 mS/cm to about 50 mS/cm, from about 1 mS/cm to about 75 mS/cm, from about 1 mS/cm to about 100 mS/cm, from about 1 mS/cm to about 150 mS/cm, from about 10 mS/cm to about 50 mS/cm, from about 10 mS/cm to about 100 mS/cm, from about 10 mS/cm to about 150 mS/cm, from about 25 mS/cm to about 75 mS/cm, from about 25 mS/cm to about 100 mS/cm, from about 25 mS/cm to about 150 mS/cm, from about 25 mS/cm to about 200 mS/cm, from about 50 mS/cm to 100 in S/cm, from about 50 mS/cm to about 150 mS/cm, from about 50 mS/cm to about 200 mS/cm, from about 100 mS/cm to about 150 mS/cm, from about 100 mS/cm to about 200 mS/cm, from about 150 mS/cm to about 200 mS/cm, and from about 175 mS/cm to about 200 mS/cm.

In some embodiments, methods of the invention comprise improving packed bed chromatography by increasing the lifespan of the packed bed. In some embodiments, methods of the invention comprise an increase in the cycle number that displays a change in transition analysis from the cycle number obtained prior to the use of the methods of the invention (hereinafter known as the “control cycle number”). In some embodiments, the methods of the invention comprise an increase of at least one or more cycles compared to the control cycle number.

In other embodiments, the extent of improvement of packed-bed chromatography performance is measured in a percent increase over the packed-bed chromatography prior to the methods of the invention (hereinafter known as “control packed bed”). In some embodiments, methods of the invention comprise at least a 10%, 20%, 30%, 40%, 50%, 60%, 70%, 80% 90%, 100%, or more increase in packed-bed chromatography performance as compared to the control packed-bed.

In other embodiments, the extent of improvement of packed-bed chromatography performance is measured as a decrease in bed integrity volume (V_{BI}). In some embodiments, methods of the invention comprise at least a 10%, 20%, 30%, 40%, 50%, 60%, 70%, 80% 90%, 100%, or more decrease in bed integrity volume as compared to the control packed-bed.

### 6. EXAMPLES

The invention is now described with reference to the following examples. These examples are provided for the purpose of illustration only and the invention should in no way be construed as being limited to these examples but rather should be construed to encompass any and all variations which become evident as a result of the teachings provided herein.

### 6.1 Example 1

### Use of Particle Size Analysis by Laser Diffraction to Investigate Bed Stability Problems of a Production Scale Packed Chromatography Bed

Methods: Industrial manufacturing scale column chromatography unit operations are well documented in the art. Column packing conditions relative to packed bed performance for extended durations, or lifetime is a phenomenon that is not well characterized. Specifically, analytical tools which can identify instability issues are not well documented in literature. In this example, a selected compressible Hydrophobic Charge Induction Chromatography (HCIC) medium (pKa 4.8) with observed manufacturing scale column lifetime problems was evaluated by particle size analysis via laser light diffraction. Aliquots of fresh HCIC medium were equilibrated as 25% slurries of medium with each process buffer of the chromatography process associated with poor lifetime. Process buffers were representative of a range of pH and conductivity conditions. Slurry samples were measured with a laser scattering particle size distribution analyzer (LA-950V2, Horiba Instruments, Inc.) using the flow cell measurement technique. The appropriate process buffer was fed into the system and de-gassed using the system air purge feature. Dispersion buffer circulation and agitation settings were optimized to minimize measurement error. HCIC medium slurry was added to the system reservoir to adjust laser light transmittance to within the appropriate range set by the equipment vendor. Consistent with theory, particle size is inversely proportional to the angle of light scatter and directly proportional to the amount of light scatter. Dispersion medium and particle refractive index were given and size distribution was calculated using software supplied with the instrument. HCIC medium particle size distribution data was collected in each process buffer and reported as the median spherical diameter. To establish instrument precision and include scientific controls in the study, bead diameter of an incompressible chromatography medium was measured in varying buffer conditions.

TABLE 1
Low buffer pH increases median diameter
of a selected HCIC medium bead

| Buffer | pH | Conductivity (mS/cm) | Median diameter (μm) |
|---|---|---|---|
| 1 | 7.0 | 4.3 | 88.3 |
| 2 | 5.2 | 0.6 | 88.4 |
| 2 | 3.0 | 3.5 | 91.9 |

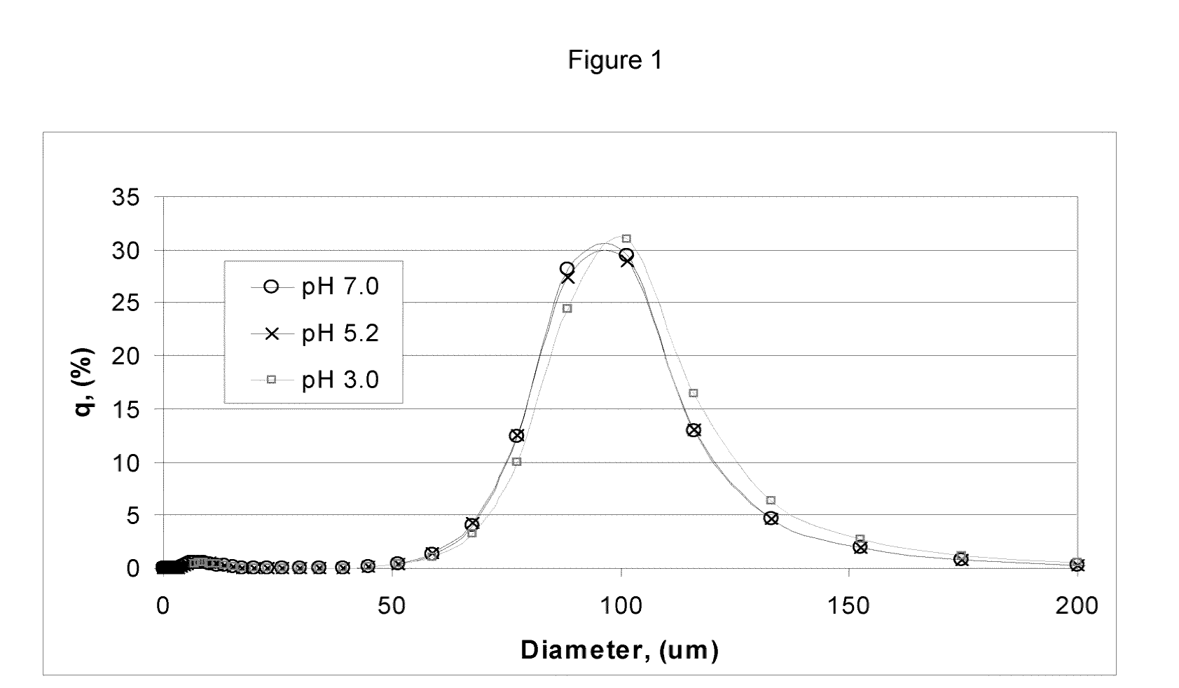

Results: Documented in Table 1 are the results from particle size analysis of the HCIC medium in varying buffer conditions. Size distribution overlays are presented in FIG. 1. These results indicate an increase in bead diameter when equilibrated at low pH (pH 3.0). Specifically, median bead diameter did not change except at the low pH condition. An increased pressure drop across a packed bed at production scale (45 cm diameter) was also observed under at the low pH condition. Therefore particle size analysis confirms historical observations in that increased column pressure at low pH is due to bead swell in a fixed volume column. Median diameter of the incompressible control medium did not exhibit a marked change (<0.3 μm) in different buffer conditions.

### 6.2 Example 2

### Correlation of Particle Size Analysis Data to Lab Scale Column Lifetime Data as a Method to Predict Production Scale Packed Chromatography Column Bed Stability

In this example in-situ bead size data was correlated to bed integrity volume (V_{BI}) and calculated non-Gaussian HETP values when the chromatography medium was exposed to repeated cycles of swelling and compression in a packed a bed. An alternative scale down model, using constant diameter-to-height aspect ratio, was applied in this study to determine the effect of bead size change on reusable column lifetime.

Methods: A scale down column (3.2 cm diameter), using a constant diameter-to-height aspect ratio versus conventional fixed bed height, was employed to characterize bed stability over multiple cycles of reuse. The medium was packed to a bed height representative of constant aspect ratio scale down from the production scale column. Historical experience was used to determine the appropriate column compression factors used in the study. In the first set of experiments, this value was set to 1.0 (representing no added compression) to give a worse-case pack in terms of expected column lifetime. Without added compression, packed bed swelling, due to bead size increase in the low pH buffer, was unrestricted. This method was expected to accelerate effects of varying buffer conditions on packed-bed stability.

The effect of the low pH buffer condition on column lifetime was evaluated by exposing lab-scale model columns to repeated process buffer cycles in the absence of protein load. Two different scenarios were evaluated based on particle size data: (1) using all process buffers, including the low pH buffer, and (2) omitting only the low pH buffer from each cycle. A control scenario (3) was included in the study by cycling all process buffers through a column packed with a 1.2 compression factor. This experiment was expected to result in a stable packed bed since the media would be restricted and not able to swell and compress as freely. A fresh column was packed for each scenario listed previously and 12 cycles were carried out for each.

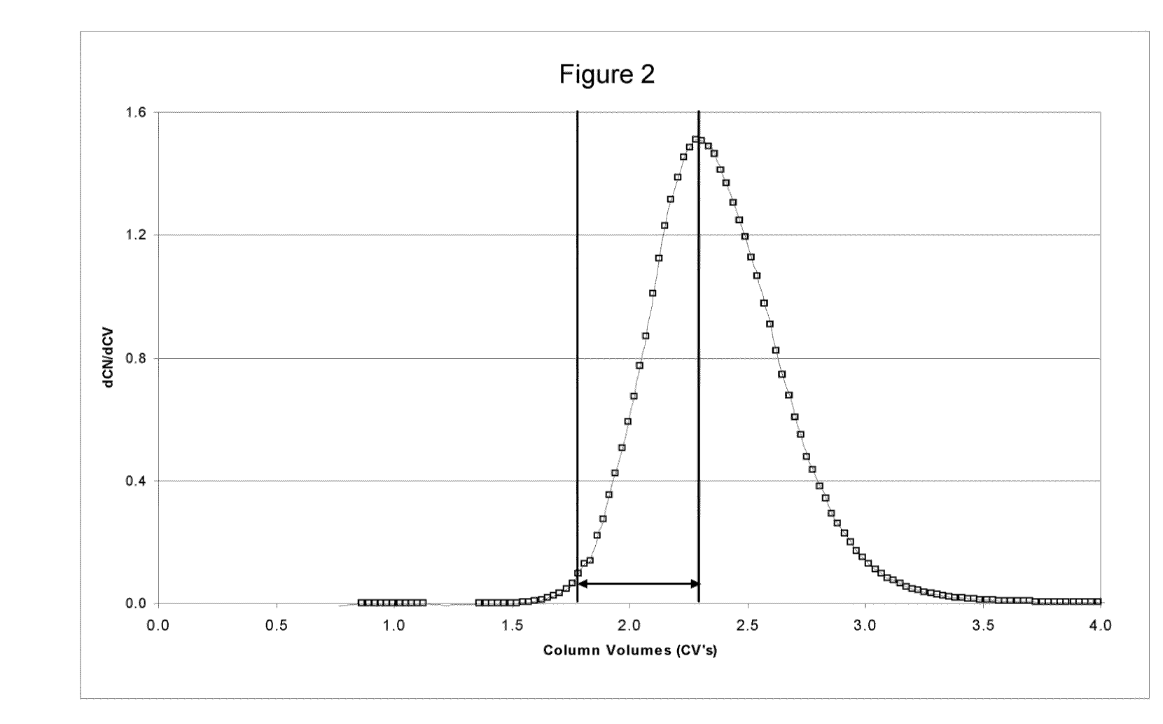

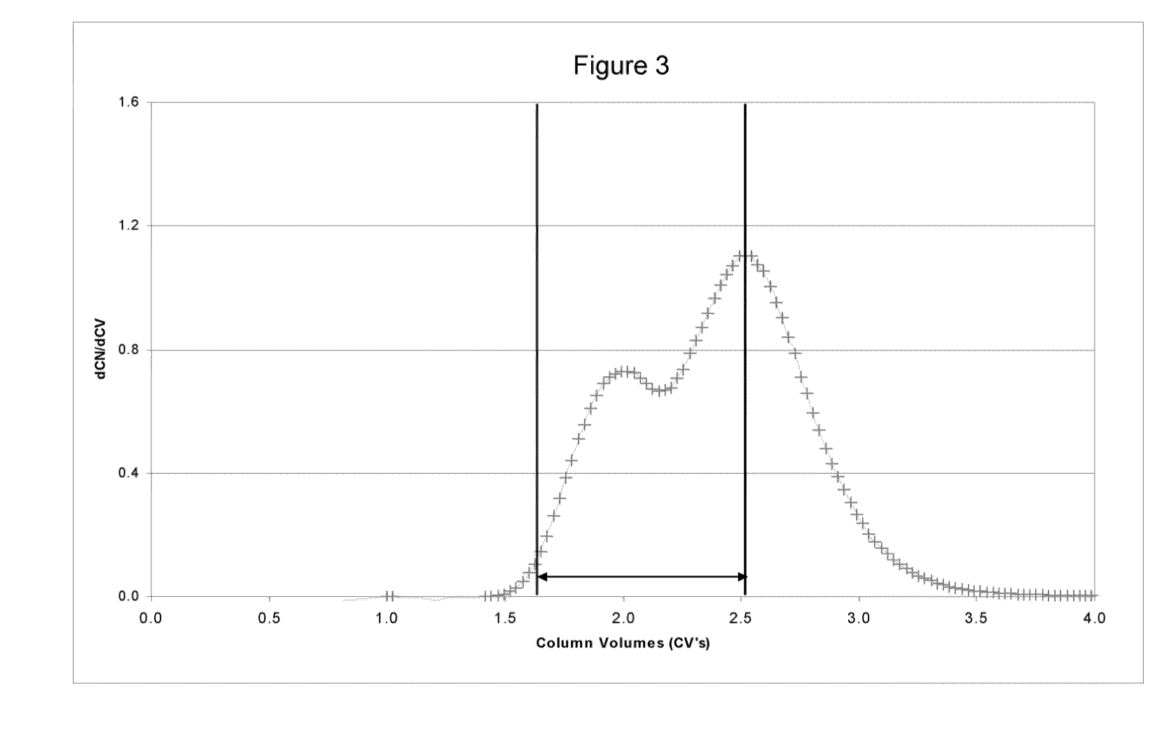

Packed bed integrity at each cycle was quantified by bed integrity volume (V_{BI}) and non-Gaussian HETP value. FIGS. 2 and 3 define V_{BI} as the volume difference (expressed as column volumes) between the peak retention time or volume, or maximum rate of change of conductivity with respect to volume, and the volume where the outlet conductivity reaches 2.5% of the transition between sanitization and storage. As the column integrity or stability degrades the value of V_{BI} increases. Both V_{BI} and HETP value were calculated by the statistical method of moments applied to the step change in conductivity response (conductivity transition) between the sanitization and storage buffer steps (high to low conductivity). Transition analysis data was calculated by a visual basic program with Microsoft Excel software. Bed integrity data was further supported by qualitative overlays of rate of change of conductivity versus totalized volume for each process cycle.

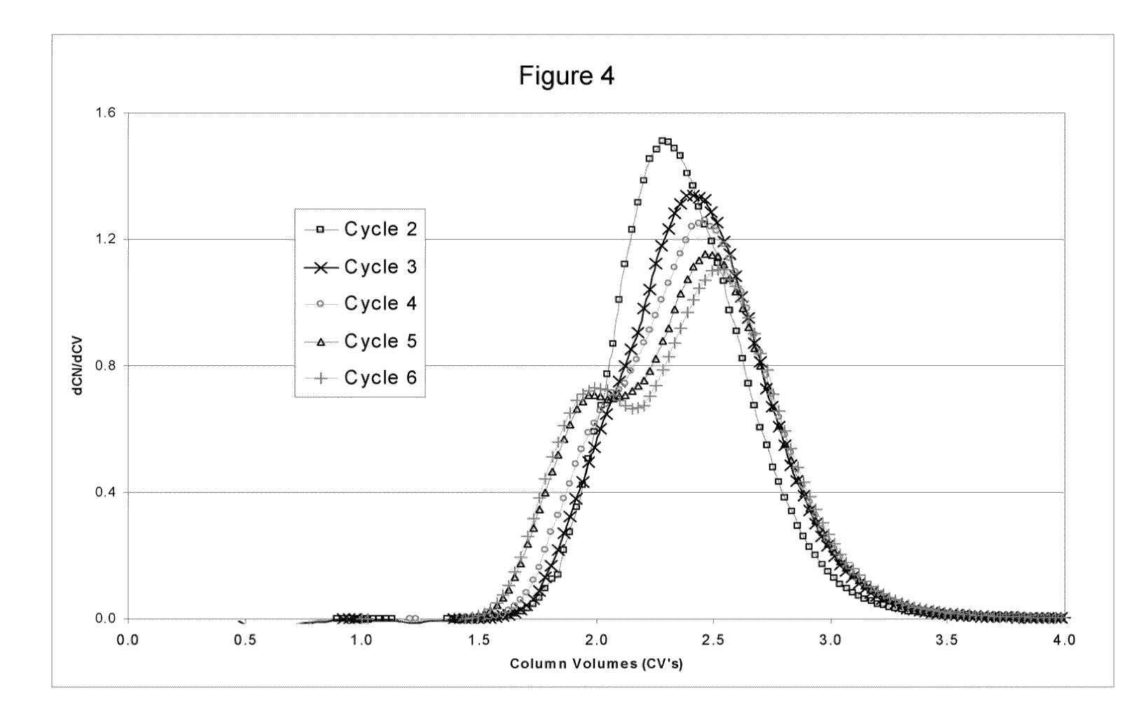

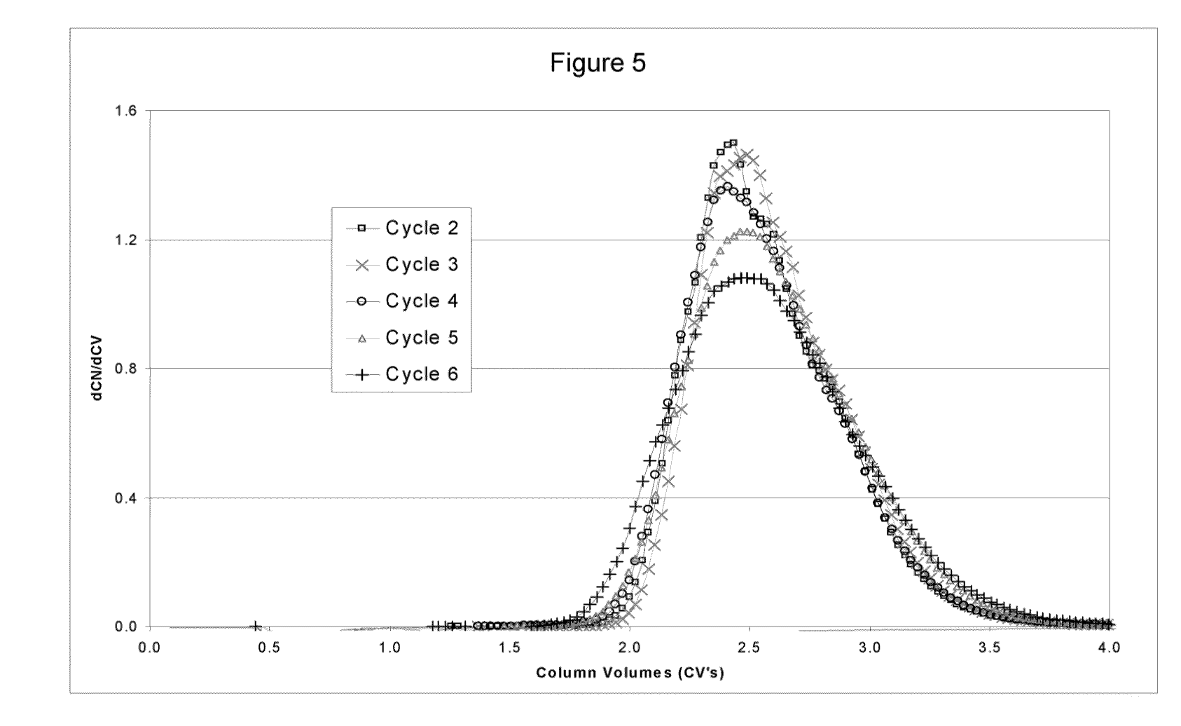

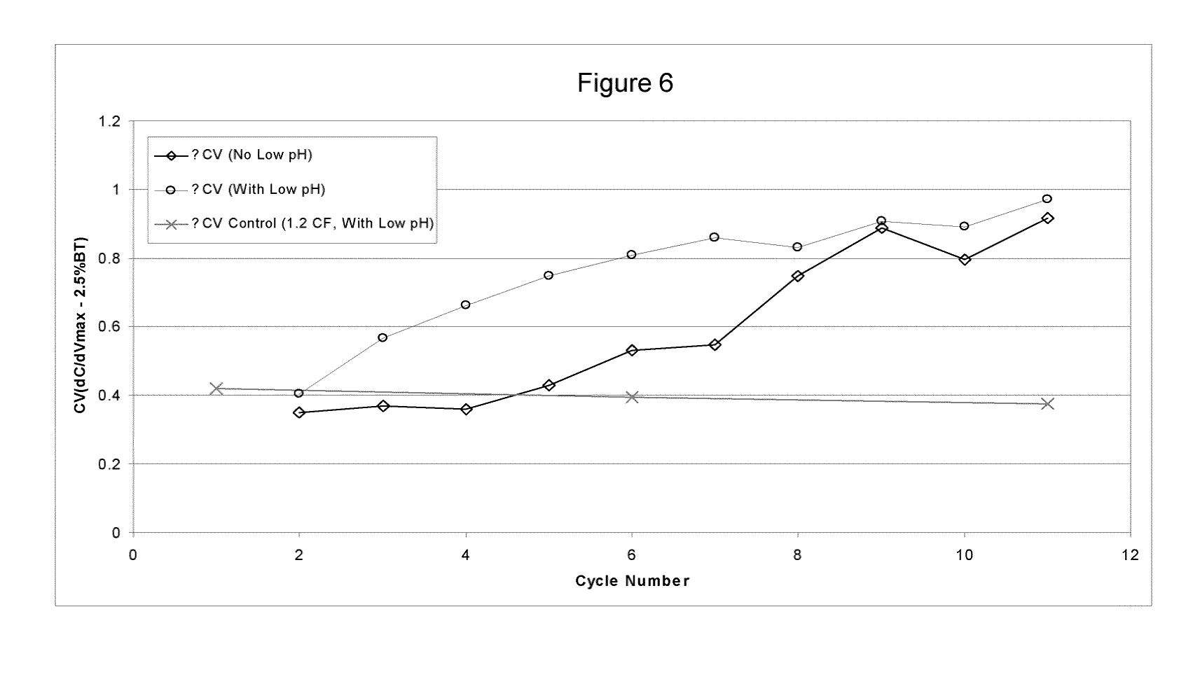

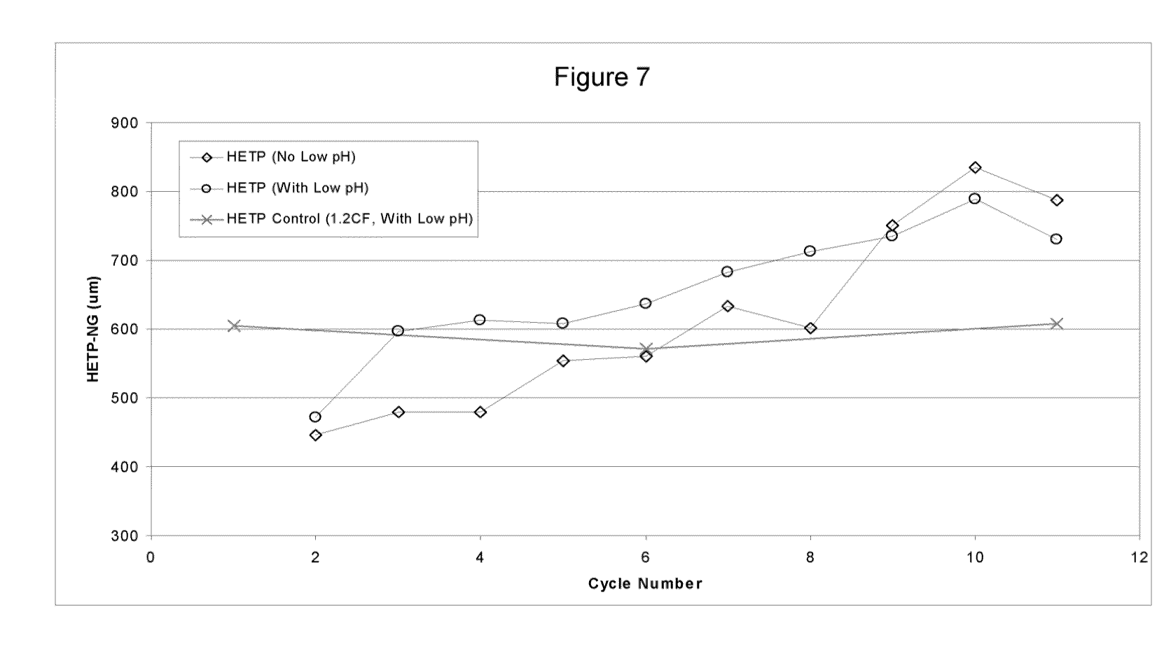

Results: FIG. 4 provides a qualitative illustration of the effect of the low pH buffer and medium bead swell on bulk packed-bed stability over multiple cycles. Decrease in column integrity or bed stability over reuse was evident by decreased 2.5% breakthrough volume, increased zone broadening, shifts in peak retention time or volume the formation of multiple inflection peaks, and increase V_{BI}. Similar to FIG. 4, FIG. 5 contains transition derivative overlays of the first six process cycles, the only difference being that the low pH buffer was omitted from the process. By comparing these figures it was apparent that the low pH buffer accelerates bed deterioration. Correlating to particle size data, these results suggested that repeated cycles of HCIC medium bead swelling and opposing compression induced by changes in pH had a dramatic effect on bed stability. If bead diameter does not change (when low pH buffer was omitted from process cycles) increased bed stability was observed. From a quantitative standpoint, FIG. 6 documents the trend of measured bed integrity over 12 process cycles. V_{BI} values increase dramatically over the first three process cycles when the low pH buffer was included in the process. When the low pH buffer was omitted from the process, V_{BI} values are stable during the first four cycles. V_{BI} for each column ultimately converged suggesting that without compression there is inherent bed instability with the buffers that were evaluated in the study. The control column, packed with a 1.2 compression factor, represented maintained packed-bed integrity over 12 cycles. FIG. 7, confirmed these trends with calculated HETP values. Thus, the trends determined by particle size analysis, that the bead diameter should not change if buffer pH remains above a threshold level (pKa 4.8) throughout the process step, were confirmed. This suggests that changes in bead size could be attributed to induced electrostatic repulsion at low pH and could be modulated to increase usable column lifetime. When correlated with packed-bed performance, particle size analysis is a valuable tool to better characterize column lifetime at increased scale. This technique may also be used as a predictive tool for screening new chromatography media and developing more robust process operations.

### 6.3 Example 3

### Real Time pH and Particle Size Data Demonstrates the Effect of pH on Particle Size

In this example, the effect of varying the pH on the particle size of the resin was analyzed in real time.

Materials and Methods: Briefly, MEP Hypercel beads were equilibrated in an acetate buffer at low pH. Initial particle size and pH was recorded. To measure particle size as a function of pH in real time, a base buffer (sodium hydroxide) was used to titrate the slurry in situ. pH measurement was tracked with a standard pH probe which was inserted into the Horiba system reservoir. pH and median particle size data was generated at multiple pH values.

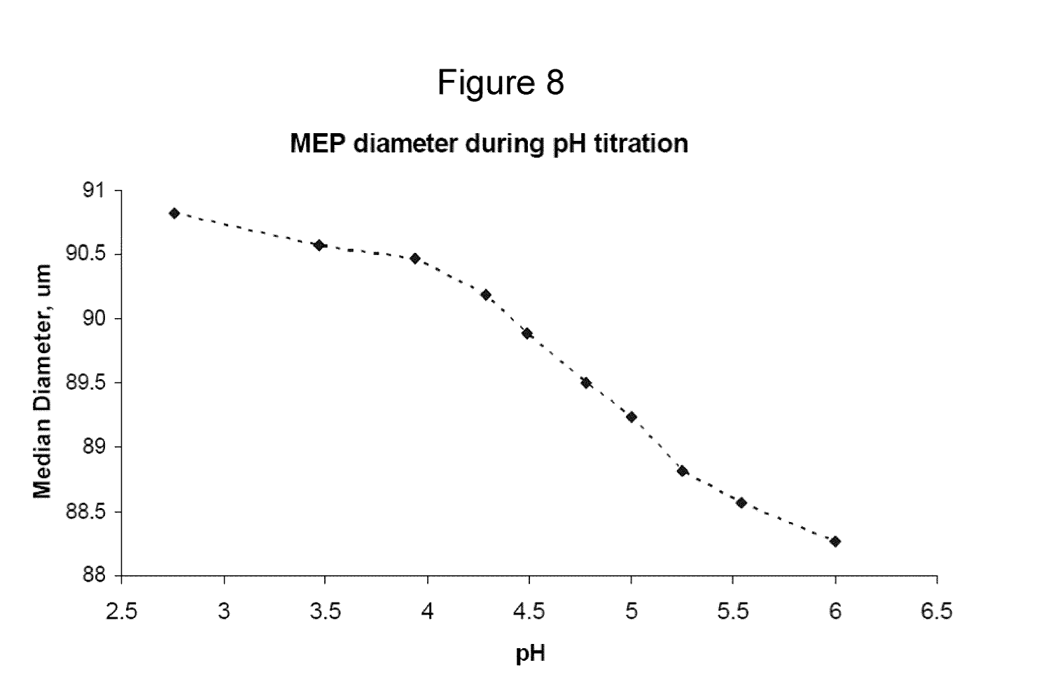

Results: Real time pH and particle size data demonstrates the effect of pH on particle size. This is useful when measurements are taken around the pKa of the ligand. In this example, using MEP Hypercel, this method established compelling evidence that the observed particle size change is indeed due to an electrostatic effect as the pH of solution drops below the pKa of 4.8 the ligand becomes positively charged which swells the beads. Electrostatic effect is evident in the figure because the rate of particle size change increases significantly as the pH passes through and beyond the pKa (see FIG. 8).

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

### 6.4 Specific Embodiments

1. A method of improving packed-bed chromatography, wherein said method comprises measuring the particle size change of a medium used in said packed-bed chromatography under varying conditions.
2. The method of embodiment 1, wherein said method further comprises correlating said size changes with channel formation in a packed-bed chromatography column.
3. The method of embodiment 1 or embodiment 2, wherein said method comprises predicting channel formation in a packed bed chromatography column based on the measured particle size change.
4. The method of any of embodiments 1-3, wherein said method comprises measuring the particle size of said medium in a slurry.
5. The method of any of embodiments 14, wherein said method comprises measuring the particle size of said medium by laser light diffraction.
6. The method of any of embodiments 1-5, wherein said varying conditions are selected from the group consisting of buffer composition, buffer pH, ionic strength, buffer temperature, buffer conductivity, and column pressure.
7. The method of any of embodiments 1-6, wherein said buffer pH is varied from a first pH to a second pH, the second pH being lower than said first pH.
8. The method of any of embodiments 1-7, wherein said buffer pH is varied from a first pH to a second pH, the second pH being higher than said pH.
9. The method any of embodiments 1-8, wherein said buffer ionic strength is varied from a first ionic strength to a second ionic strength, said second ionic strength being less than the first ionic strength.
10. The method any of embodiments 1-9, wherein said buffer ionic strength is varied from a first ionic strength to a second ionic strength, said second ionic strength being greater than the first ionic strength.
11. The method any of embodiments 1-10, wherein said buffer conductivity is varied from a first conductivity to a second conductivity, said second conductivity being less than the first conductivity.
12. The method of any of embodiments 1-11, wherein said buffer conductivity is varied from a first conductivity to a second conductivity, said second conductivity being greater than the first conductivity.
13. The method any of embodiments 1-12, wherein said pH is varied from around 7.0 pH units to about 5.2 pH units.
14. The method of any of embodiments 1-13, wherein said pH is varied from about 5.2 pH units to about 3.0 pH units.
15. The method of any of embodiments 1-14, wherein said pH is varied from about 3.0 pH units to about 7.0 pH units.
16. The method of any of embodiments 1-15, wherein said pH is varied in a first step from about 7.0 pH units to about 5.2 pH units, and varied in a second step from about 5.2 pH units to about 3.0 pH units, and varied in a third step from about 3.0 pH units to about 7.0 pH units.
17. The method of any of embodiments 1-16, wherein said method comprises repeating a cycle of said first, second and third steps sequentially.
18. The method of any of embodiments 1-17, wherein said method comprises measuring the particle size change of the medium after each cycle.
19. The method any of embodiments 1-18, wherein said medium is a compressible medium.
20. The method any of embodiments 1-19, wherein said chromatography is selected from the group consisting of ion-exchange, reversed-phase, cation exchange, anion exchange, size exclusion, hydrophobic charge induction, affinity, and hydrophobic interaction chromatography.
21. The method any of embodiments 1-20, wherein said medium is selected from the group consisting of MonoS, MiniS, Source 15S, Source 30S, SP Sepharose Fast Flow, SP Sepharose High Performance, Toyopearl SP-650S, Toyopearly SP-650M, Macro-Prep High S, Ceramic HyperD5, Trisacryl M, Spherodex LS SP, Fractogel SE, Poros S, Poros S-20, TSK Gel SP 5PW, TSK SP-5PW-HR, Poros HS-20, Poros HS-50, Fractogel EMD SO₃, SE52, SE53, Express-Ion S, CM Sepharose Fast Flow, Macro-Prep CM, Ceramic HyperD CM, Trisacryl M CM, Trisacryl LS CM, Matrix Cellufine C500, Matrix Cellufine C200, CM52, CM32, CM23, Express Ion C, Toyopearl CM-650S, Toyopearl CM-650M, Toyopearl CM-650C, BAKERBOND Carboxy-Sulfon, WP CBX, DOWEX MAC-3, DOWEX Weak Cation Exchanger, Diaion Weak Cation Exchanger, Fractogel EMD COO—, Hydrocell SP, DOWEX Fine Mesh Strong Acid Cation Resin, UNOsphere 5, WP Sulfonic, Sartobind S, Amberlite Strong Cation Exchanger, P11, and MEP HYPERCEL.
22. The method any of embodiments 1-21, wherein said buffer is selected from the group consisting of acetate, citrate, histidine, phosphate, ammonium acetate, ammonium succinate, 18-MES, CHAPS, MOPS, MOPSO, HEPES, Tris, TRIS-malic acid-NaOH, maleate, chioroacetate, formate, benzoate, propionate, pyridine, piperazine, ADA, PIPES, ACES, BES, TES, tricine, bicine, TAPS, ethanolamine, CHES, CAPS, methylamine, piperidine, o-boric acid, carbonic acid, lactic acid, butaneandioic acid, diethylmalonic acid, glycyiglycine, HEPPS, HEPPSO, imidazole, phenol, POPSO, succinate, TAPS, amine-based, benzylamine, trimethyl or dimethyl or ethyl or phenyl amine, ethylenediamine, and mopholine.
23. The method any of embodiments 1-22, wherein said packed-bed chromatography is for antibody purification.
24, The method of any of embodiments 1-23, wherein said packed-bed chromatography exhibits an increase in cycle number as compared to the control cycle number.
25. The method of any of embodiments 1-24, wherein said packed-bed chromatography exhibits an increase in packed-bed chromatography performance as compared to the control packed-bed.
26. The method of any of embodiments 1-25, wherein said packed-bed chromatography exhibits a decrease in bed integrity volume as compared to the control packed-bed.

We claim:

1. A method of improving packed-bed chromatography, wherein said method comprises:
a. measuring the particle size change of a medium used in said packed-bed chromatography under varying conditions.
b. correlating said size changes with channel formation in a packed-bed chromatography column; and
c. predicting channel formation in a packed bed chromatography column based on the measured particle size change.

2. The method of claim 1, wherein said method comprises measuring the particle size of said medium in a slurry.

3. The method of claim 1, wherein said method comprises measuring the particle size of said medium by laser light diffraction.

4. The method of claim 1, wherein said varying conditions are selected from the group consisting of buffer composition, buffer pH, ionic strength, buffer temperature, buffer conductivity, and column pressure.

5. The method of claim 4, wherein said buffer pH is varied from a first pH to a second pH, the second pH being lower than said first pH.

6. The method of claim 4, wherein said buffer pH is varied from a first pH to a second pH, the second pH being higher than said pH.

7. The method of claim 4, wherein said buffer ionic strength is varied from a first ionic strength to a second ionic strength, said second ionic strength being less than the first ionic strength.

8. The method of claim 4, wherein said buffer ionic strength is varied from a first ionic strength to a second ionic strength, said second ionic strength being greater than the first ionic strength.

9. The method of claim 4, wherein said buffer conductivity is varied from a first conductivity to a second conductivity, said second conductivity being less than the first conductivity.

10. The method of claim 4, wherein said buffer conductivity is varied from a first conductivity to a second conductivity, said second conductivity being greater than the first conductivity.

11. The method of claim 4, wherein said pH is varied:
a. from about 7.0 pH units to about 5.2 pH units;
b. from about 5.2 pH units to about 3.0 pH units; or
c. from about 3.0 pH units to about 7.0 pH units.

12. The method of claim 4, wherein said pH is varied in a first step from about 7.0 pH units to about 5.2 pH units, and varied in a second step from about 5.2 pH units to about 3.0 pH units, and varied in a third step from about 3.0 pH units to about 7.0 pH units.

13. The method of claim 12, wherein said method comprises repeating a cycle of said first, second and third steps sequentially.

14. The method of claim 13, wherein said method comprises measuring the particle size change of the medium after each cycle.

15. The method of claim 1, wherein said medium is a compressible medium.

16. The method of claim 1, wherein said chromatography is selected from the group consisting of ion-exchange, reversed-phase, cation exchange, anion exchange, size exclusion, hydrophobic charge induction, affinity, and hydrophobic interaction chromatography.

17. The method of claim 1, wherein said packed-bed chromatography is for antibody purification.

18. The method of claim 1, wherein said packed-bed chromatography exhibits an increase in cycle number as compared to the control cycle number.

19. The method of claim 1, wherein said packed-bed chromatography exhibits an increase in packed-bed chromatography performance as compared to a control packed-bed.

20. The method of claim 1, wherein said packed-bed chromatography exhibits a decrease in bed integrity volume as compared to a control packed-bed.
